(19) United States
(12) Patent Application Publication
(10) Pub. No.: US 2009/0107037 A1
(43) Pub. Date: Apr. 30, 2009

(54) Revolving Apparatus for Agriculture Products Cultivation Beds

(76) Inventor: Zahar Alinski, Arad (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 10/595,512

(22) PCT Filed: Oct. 26, 2003
(86) PCT No.: PCT/IL2004/000976

§ 371 Date: Sep. 10, 2008

(30) Foreign Application Priority Data
Oct. 26, 2003 (IL) 158601

(51) Int. Cl. A01G 1/04; A01G 13/00

(52) U.S. Cl. 47/1.1; 47/65

(57) ABSTRACT

The present invention discloses an apparatus which is designed to hold a plurality of cultivation beds for mushrooms or other agricultural products, each rotating on two different axes. The three disclosed embodiments operate according to different configurations but all provide similar functionality for the apparatus, enabling the frames holding the cultivation beds to rotate in two different circular motions independently or in congruence. The overall design of the preferred embodiments of the apparatus resemble that of an elaborate Ferris wheel and includes a central wheel assembly, and a number of secondary wheel assemblies each holding a plurality of cultivation beds which are positioned on the perimeter of the central wheel assembly. The first rotating motion is around the axis of the central wheel and the second is of each secondary rotating mechanism around its axis.

### BACKGROUND OF THE INVENTION

1. Field of the Invention

The present invention relates to the field of the cultivation of mushrooms or other agricultural products. More particularly, the invention relates to a method and apparatus for the cultivation of such products throughout their development. The invention seeks to provide a convenient solution for mushroom cultivation while providing easy access for cultivation and cropping.

2. Brief Summary of the Related Art

Mushrooms or other agricultural products must be cultivated under specific conditions in specially designed housing facilities that maintain exact temperature, carbon dioxide content and humidity of the air in accordance with the stage of growth of the mushrooms. This limits the amount of space available for mushroom cultivation.

Several space saving solutions have been suggested in the past. A widely used system currently in use involves growing the mushrooms in long beds raised on platforms along the walls of a housing facility. The platforms are positioned one above the other in a manner much like hanging shelves. This system is advantageous in that it utilizes much of the available space and provides adequate ventilation. However, these platform beds are difficult to maintain since the user must reach each platform separately, sometimes having to use a stool or a ladder to reach beds that are positioned higher on the wall, in order to spread compost, water, crop the mushrooms or perform any other task required during cultivation.

European patent no. EP0324607 describes horizontally and vertically movable equipment for cultivation mushrooms or other products. The equipment consists of a plurality of beds positioned side by side and one above the other, and are pivotally attached at their ends to two chains, which are carried between upper and lower sprocket wheels. Each bed can be moved to a position in which a user can comfortably tend to the mushrooms while sitting or standing. This apparatus is preferable over the existing system but has some disadvantages, among which are the large size, machine costs and maintenance cost.

The present invention suggests an apparatus that maintains ventilation, allows easy access to the mushrooms, and utilizes maximal amount of available space. This freestanding apparatus consists of multiple units, each containing a plurality of vertically rotating beds. Each unit is also connected to the central axis of the apparatus and the units rotate in a similar fashion to the beds within them. The design of the apparatus is reminiscent to that of a Ferris wheel at an amusement park. Greek patent no. GR1002430 provides a similar but a simpler apparatus designed for breeding silkworms.

### SUMMARY OF THE INVENTION

The present invention provides a rotating cultivation system, for cultivating mushrooms, which holds a plurality of trays enabling the movement of each tray to a specific location. The system is comprised of a main wheel assembly having a rotating mechanism at the central axis controlled by an electric or hydraulic motor and two frames having supporting spokes projecting from the central axis and a secondary wheel assemblies each having a central axis and two frames of spokes extending from the secondary axis wherein each spoke holds a tray, wherein the central axes of the secondary wheel assemblies are located at the edges of the main wheel assembly supporting spokes and the rotation of the secondary wheel assemblies is independent of the main wheel assembly rotation.

The rotation of all secondary wheel assemblies is controlled by a central rotating mechanism which include a second electric or hydraulic motor and a gear assembly which enables the rotation of all secondary wheel assemblies simultaneously.

### BRIEF DESCRIPTION OF THE DRAWINGS

These and further features and advantages of the invention will become more clearly understood in the light of the ensuing description of a preferred embodiment thereof, given by way of example only, with reference to the accompanying drawings, wherein

FIG. 1 is a front view of the apparatus assembled in accordance with the first embodiment of the present invention;

FIG. 2 is a perspective view of the apparatus assembled in accordance with the first embodiment of the present invention;

FIG. 3 is perspective view of the main wheel assembly according to the first embodiment of the present invention;

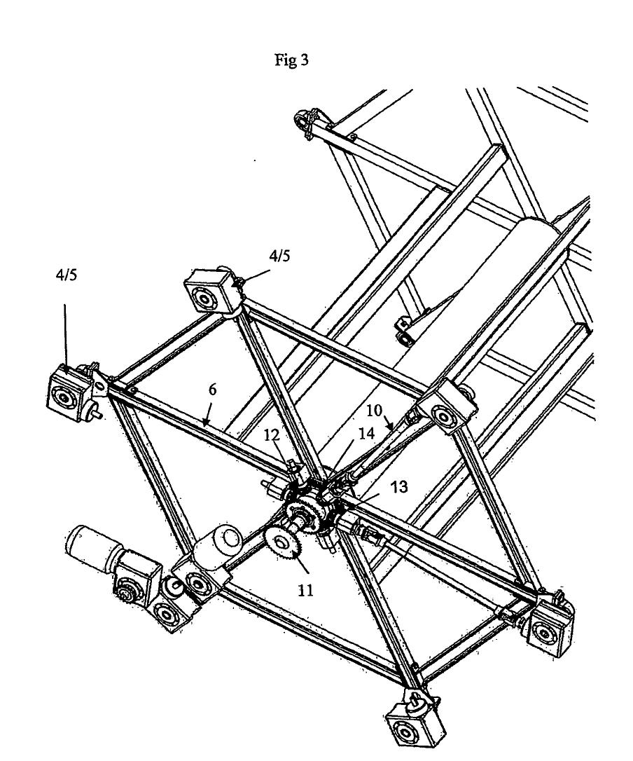

FIG. 4 is an enlarged perspective view of the main wheel assembly according to the first embodiment of the present invention;

FIG. 5a is an enlarged perspective view of the control unit according to the first embodiment of the present invention;

FIG. 5b is an enlarged perspective cross section of the control unit according to the first embodiment of the present invention;

FIG. 5c is an enlarged top view of the control unit according to the first embodiment of the present invention;

FIG. 5d is an enlarged front cross section of the control unit according to the first embodiment of the present invention;

FIG. 6 is an enlarged perspective view of the control unit assembled with the shafts according to the first embodiment of the present invention.

FIG. 7 is an enlarged perspective view of a secondary wheel assembly according to the first embodiment of the present invention;

FIG. 8 is an enlarged perspective view of a cultivation bed according to the first embodiment of the present invention.

FIG. 9 is a front view of the apparatus assembled in accordance with the second embodiment of the present invention;

FIG. 10 is a front view of the apparatus assembled in accordance with the third embodiment of the present invention;

### DETAILED DESCRIPTION OF THE PREFERRED EMBODIMENTS

The apparatus described in the present invention is designed to hold a plurality of cultivation beds for mushrooms or other agricultural products each rotating on two different axes. The three disclosed embodiments operate according to different configurations but all provide similar functionality for the apparatus, enabling the frames holding the cultivation beds to rotate in two different circular motions independently or in congruence.

The overall design of the first embodiment of the apparatus resembles that of a Ferris wheel and includes a main wheel assembly A, main rotating mechanism 2, a number of secondary wheel assemblies B, the same number of secondary rotating mechanisms 4, a control unit C, a triangular stand D, and a plurality of cultivation beds E. The apparatus may be constructed of various types of materials including metal, plastic, etc.

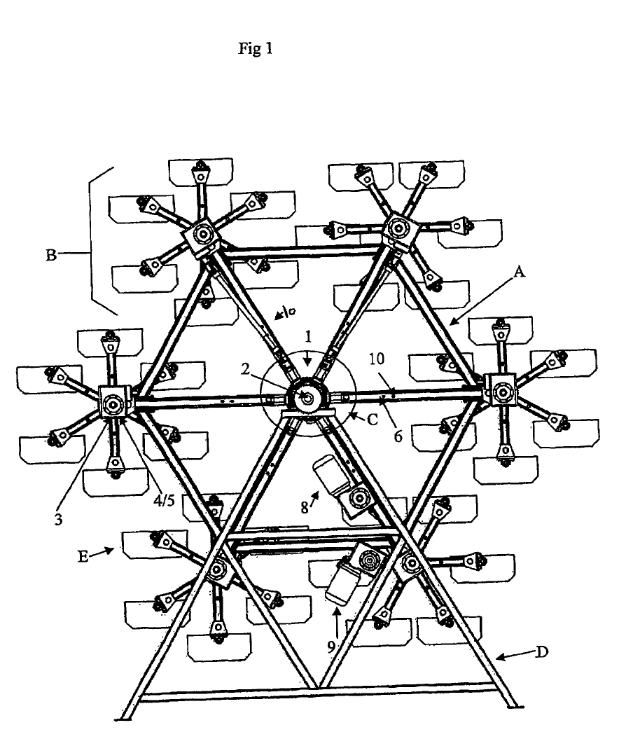

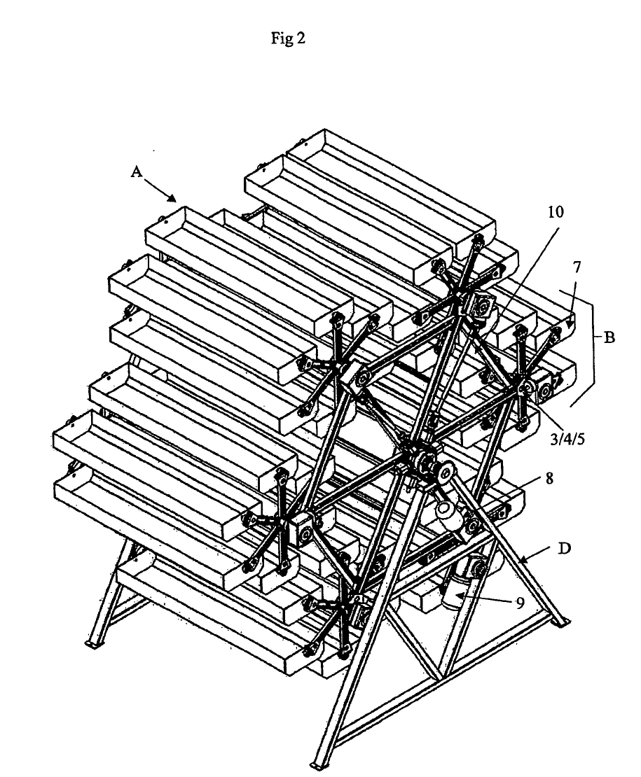

The main wheel assembly A is shown in FIGS. 1 and 2. Referring to these figures, the main wheel assembly A consists of two frames in the shape of polygons with stabilizing spokes 6. The frames are connected at the main axis 1 in their centers by an elongated spool. The control unit C and main rotating mechanism 2 of the apparatus are positioned at the center of one of the frames next to the main axis 1. A number of gear housings 5 are attached to the vertices of the polygon frame, and the same number of shafts 10 project from the control unit C along the spokes 6 of the frames and connect to the gear housings 5.

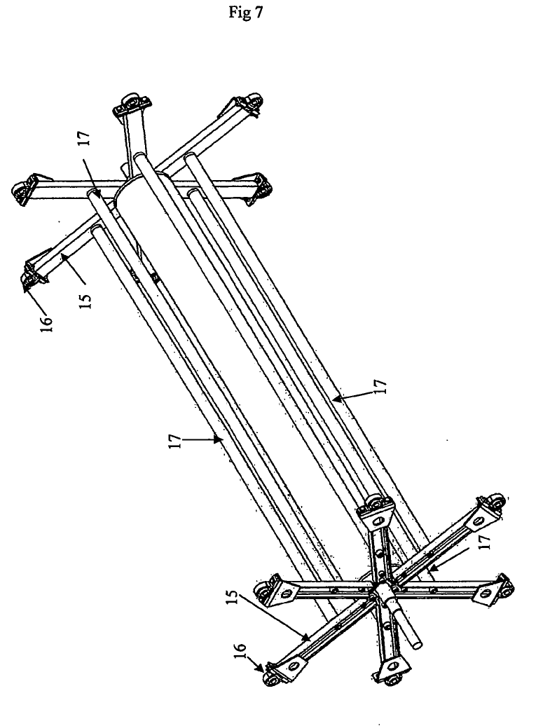

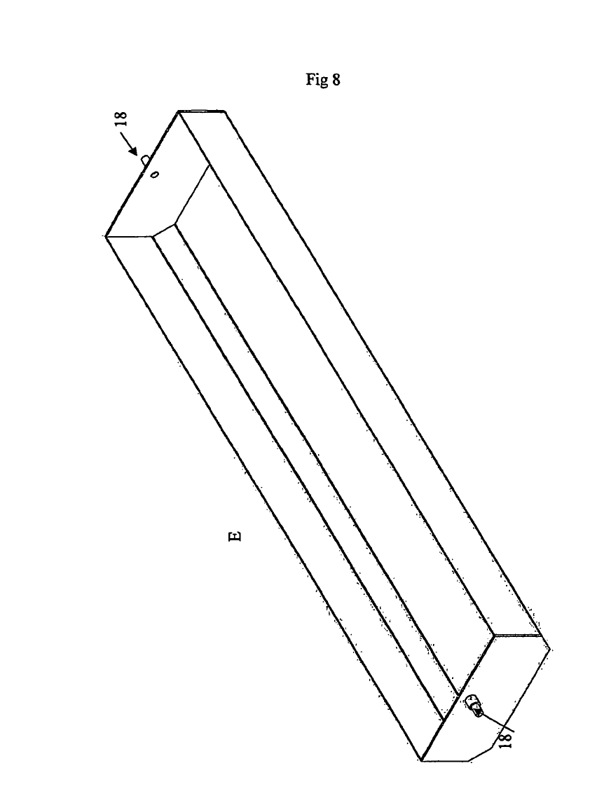

The secondary wheel assemblies B, one of which is illustrated in FIG. 7, hold the cultivation beds E. Each secondary wheel assembly B consists of two frames containing a number of spokes 15. The frames are connected at their central axis, which is also a secondary axis 3 of the entire apparatus, by an elongated spool. A number of smaller stabilizing cylindrical 17 bars are also positioned between each two respective spokes 15 on opposite frames. Each cultivation bed is positioned between two such corresponding spokes 15. The spokes 15 have rounded ends 16 with holes to accommodate the pins 18 positioned on each side of the cultivation beds E (see FIG. 8). Each cultivation bed E is free to rotate on its own axis according to its current position on the apparatus. As a result, the beds E will maintain their vertical position regardless of the entire unit's rotation due to gravity.

The secondary wheel assemblies B are connected at their central axes 3 to the gear housings 5, which connect them to the main wheel assembly A. Within the gear housings 5 are secondary rotating mechanisms 4 that rotate the secondary wheel assemblies B. These mechanisms 4 turn adjacent secondary wheel assemblies B in alternating directions to conserve space while avoiding clashes.

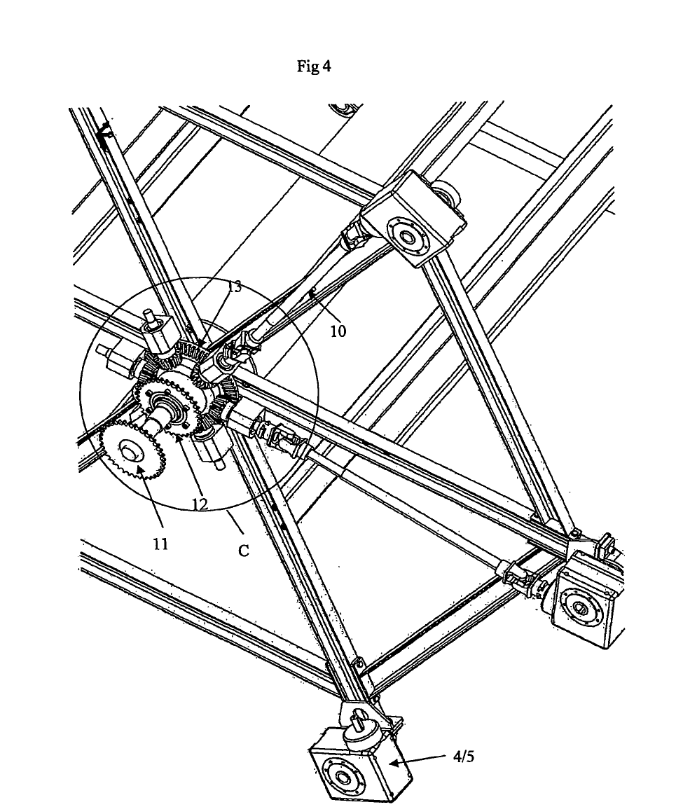

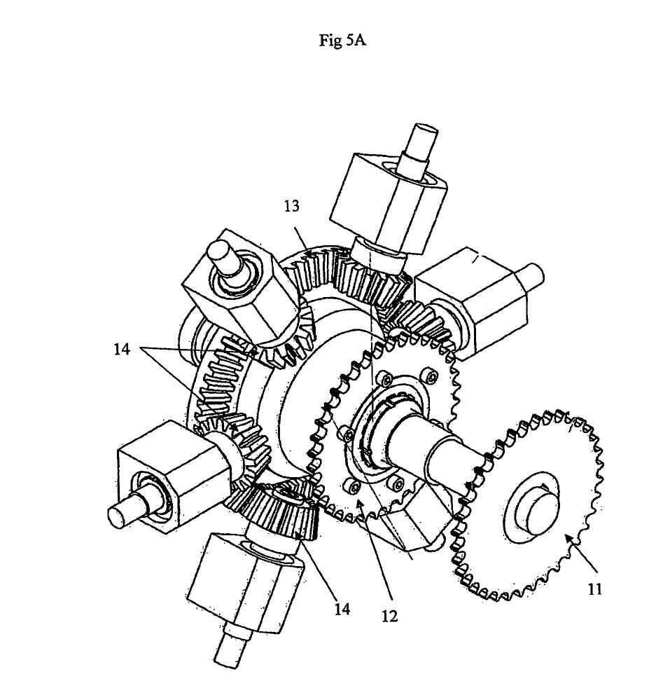

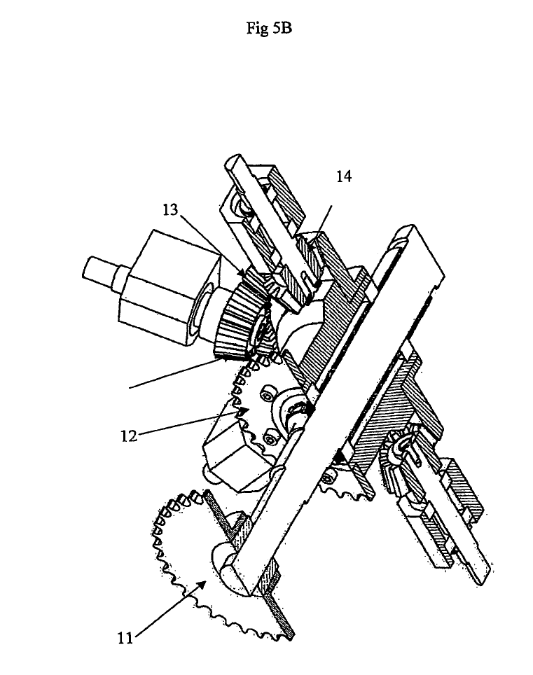

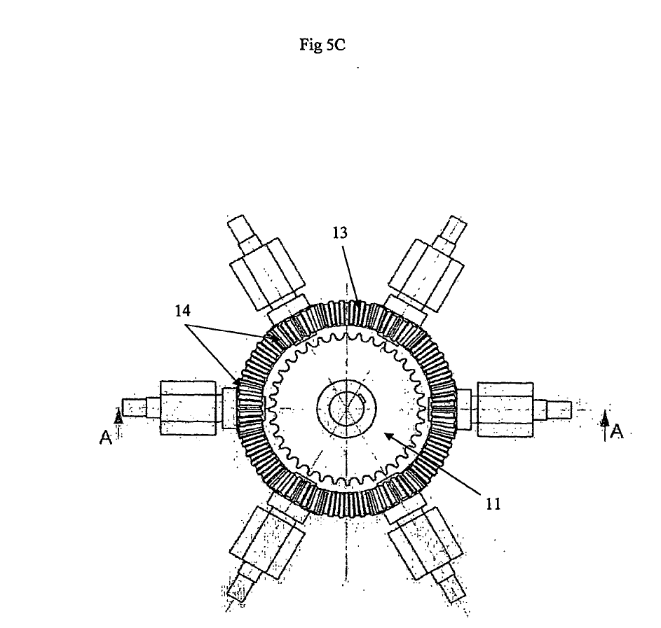

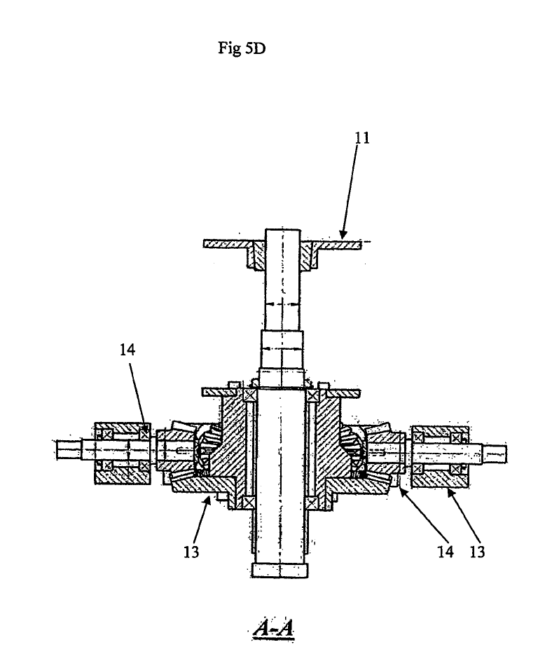

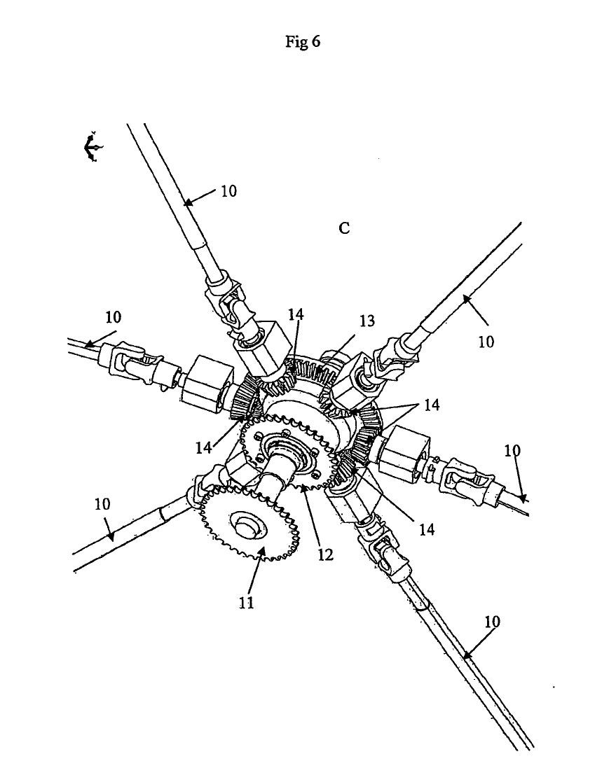

All of the rotating mechanisms 2, 4 within the apparatus are controlled by the control unit C, which is shown in FIG. 5 and consists of two large gears 11, 12, a circular rack 13, and a number of small gears 14 corresponding to the number of secondary wheel assemblies B used in the apparatus. As mentioned above, the control unit C is positioned in the center of one of the frames of the main wheel assembly A, i.e. at the main axis 1. A ball bearing separates the two large gears 11, 12 in the control unit so that each gear may be turned independently from the other. The main gear 11 turns the main rotating mechanism 2, which rotates the main wheel assembly A on the main axis 1. The secondary gear 12 turns the rack 13, which turns all of the small gears 14 placed on it. These gears 14 are connected to the protruding shafts 10 using cardan joints, as shown in FIG. 6, while the shafts are connected to the secondary rotating mechanisms 4 as shown in FIG. 4. Therefore, the rotation of this gear 12 on the control unit C results in the rotation of all of the secondary wheel assemblies 4—on the secondary axes 3—at once.

Referring again to FIGS. 1 and 2, the triangular stand D is also constructed of two frames corresponding to the frames of the main wheel assembly A. The frame of the stand that attaches to the main wheel frame containing the control unit C described above also holds the motors 8, 9 designated to turn the rotating mechanisms 2, 4. Using two separate motors 8, 9 for the two gears 11, 12 in the control unit allows the rotating mechanisms 2, 4 to operate independently. This stand D serves the purpose of raising the main wheel assembly A from the floor but also connects to the control unit C in order to transfer the energy from the motors 8, 9 to the rotating mechanisms 2, 4. The motor 8, 9 may be electrical or hydraulic motors.

A different implementation of the first embodiment involves the use of the same parts and mechanisms described above, while the shafts 10 protruding from the central unit C are replaced by metal chains that perform the same function as these shafts 10.

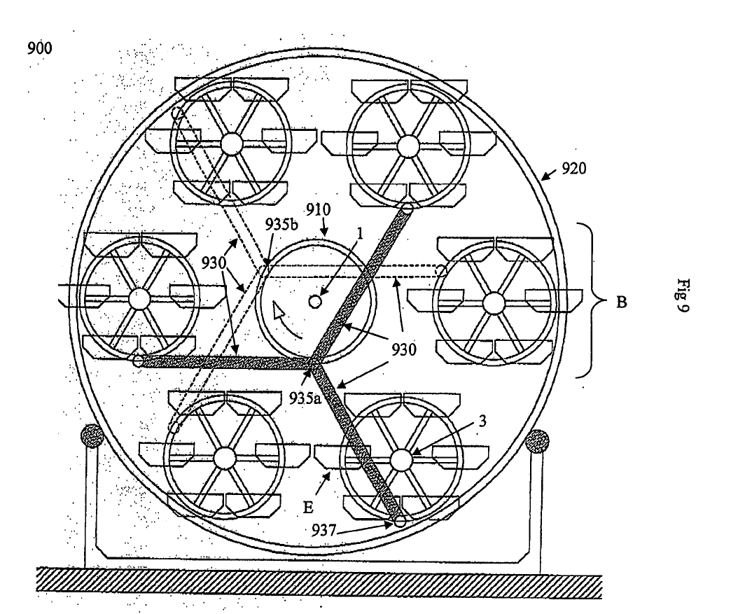

The second embodiment of the present invention is illustrated in figure 9. The apparatus 900 is composed of two concentric wheels; a central rotating wheel 910 and an external rotating wheel 920, whereas each of them is rotated by an individual motor (not shown). Positioned between the two wheels and tangential to the external wheel 920 are six secondary wheel assemblies B, which as in the first embodiment hold the cultivation beds E.

Six rods 930 connect the central rotating wheel 910 and the secondary wheel assemblies B. All six rods 930 are attached to the central rotating wheel 910, and each rod is attached to a single secondary wheel assembly B via joint 937. Three rods are connected to one side of the central wheel 910 at joint 935a and the other three are connected to the other side of wheel 910 at joint 935b; the two sides of wheel 910 are connected by a gear and they rotate in opposite directions. The rotation of the central wheel 910 therefore causes each of the secondary wheel assemblies B to rotate on its axis 3, whereas each secondary wheel assembly B rotates in an alternate direction in relation to its two neighboring units.

Each of the secondary wheel assemblies B is also connected to the external wheel 920. The rotation of the external wheel 920 causes the whole apparatus to rotate around the central axis 1. The combination of circular movements around axes 1 and 3 enables each of the cultivation beds E to reach any position in the perimeter of the external wheel 920.

As FIG. 9 clearly illustrates, unlike the first embodiment, the apparatus 900 does not rest on its central axis, but instead is situated on its external wheel 920. The external wheel 920 is positioned on bearings (bogies) 945 of stand 940, which allow the external wheel 920 a full 360 degrees rotation in either direction.

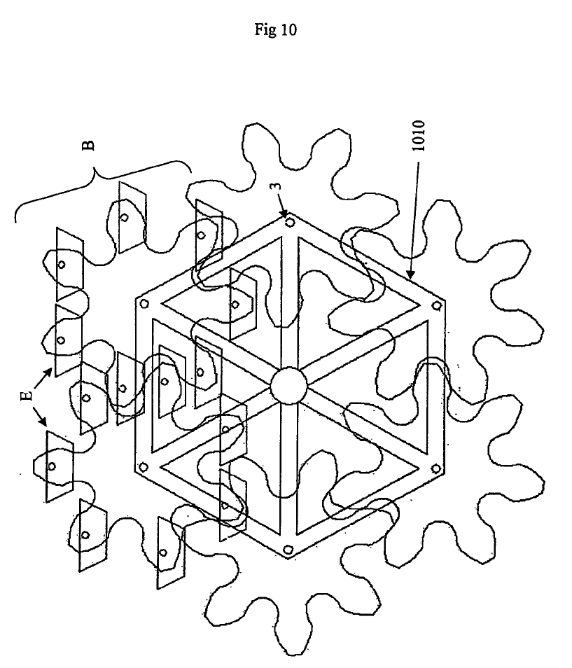

The structure of the third embodiment, a schematic illustration of which is in FIG. 10, also enables operating a similar combination of circular motions by only two motors. The apparatus is comprised of a central polygon frame and secondary assemblies B. The axes of the secondary assemblies 3 are positioned at the vertices of polygon 1010. Similarly to the first embodiment the polygon 1010 is supported on its axis by a triangular stand D (not shown in FIG. 10, see FIGS. 1, 2).

The secondary assemblies B, which similarly to the previous embodiments hold the cultivation beds E, are shaped as big cogwheels. As is clear from the assembly's illustration (FIG. 10) the cogwheel-shaped secondary assemblies B are positioned in a proximity which assures that the rotation of a single secondary assembly B on its axis 3 causes all other secondary assemblies B to rotate on theirs. The two rotating motions may then be achieved by two motors: a motor which rotates the entire apparatus around the central axis 1 and a second motor which is connected to a single secondary assembly B and rotates it on its axis 3, but in fact causes all secondary assemblies B to rotate on their axes in alternate directions simultaneously.

An additional preferred embodiment of the present invention is similar to the embodiment described above, but suggests the use of a separate motor for each of the secondary wheel assemblies. This embodiment is more costly but allows for greater accessibility and more options for the rotation of the trays.

Although the apparatus described in the present invention may be used for cultivation of various different products, it is especially beneficial for cultivation and harvesting of mushrooms or other agricultural products. For the cultivation of mushrooms, the cultivation trays may be removed and sterilized either individually, together, or in any particular order that the user wishes.

The trays may then be replaced and soil may be poured into the trays two at a time from either side of the apparatus in order to maintain the balance of the apparatus. Any type of soil may be used; however, the relatively large surface area of the cultivation trays described in the present invention causes the invention to be particularly advantageous with the use of heat-emitting soil such as used for mushroom cultivation.

Although housing facilities for the cultivation of mushrooms or other agricultural products are air conditioned, the temperature and quality of the air may still differ in various areas and/or heights within the room. In the present invention, two or more different rotations of the cultivation beds assure proper and even ventilation of the mushrooms or other product in all stages of cultivation. The apparatus can rotate the mushrooms unsupervised on the main axis, secondary axes, an individual secondary axis, or all axes at once. A timer may be attached to one or more of the motors in order to automatically rotate the mushrooms for predefined periods of time.

In all embodiments, the rotational feature of the present invention also allows for easy access to any specific cultivation bed since the rotation of the bed units vice versa is independent from that of the entire frame. The user may sit or stand in one place on either side and at any height around the apparatus and rotate any cultivation bed to its desired location at the touch of a button. This feature may facilitate the integration of automatic harvesting means, such as a harvesting robot especially designed for a specific type of an agricultural product, since the automatic rotation of the cultivation beds allows the robot to be stationary. It also allows for simultaneous cultivation or harvesting by more than one person. The ability to increase manpower gives the user/s more options and can result in greater efficiency.

While the above description contains many specifities, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

What is claimed is:

1. A rotating cultivation system for holding a plurality of cultivation beds enabling a rotation of said beds, said system comprising:
at least one central rotating mechanism and at least one external rotating wheel;
a plurality of secondary wheel assemblies connected to the external rotating wheel that allows rotation of said assemblies around the external rotating wheel's axis, wherein each assembly holds at least one cultivation bed; and
at least one stand, supporting each external wheel, where said stand comprises bearing, where said external wheel is mounted upon said bearings that allow the external wheel to rotate, wherein the rotation of the external rotating wheel causes the whole apparatus to rotate around the central axis of said wheel; and
wherein each assembly is connected to said at least one central rotating mechanism by at least one frame enabling each assembly to rotate around its own axis, wherein the rotation of said assemblies around the external wheel's axis is independent of said assemblies' rotation around their own axes.

2. The system of claim 1 wherein each secondary wheel assembly includes a central axis and at least two frames of spokes extending from the central axis of the wheel wherein each spoke holds a cultivation bed.

3. (canceled)

4. The cultivation system of claim 1 wherein the rotation of all secondary wheel assemblies is controlled by the central rotating mechanism which includes a second motor and a gear assembly enabling the rotation of all secondary wheel assemblies substantially simultaneously.

5. The cultivation system of claim 3 wherein said second motor and gear assembly are mounted on the external rotating wheel.

6. The cultivation system of claim 3 wherein the central rotating mechanism transfers the rotational movement through gears and shafts wherein a main gear rotates respective small gears and each small gear transfers the motion to a respective secondary wheel assembly through the shaft rotation.

7. The cultivation system of claim 3 wherein the central rotating mechanism transfers the rotational movement through gears and chains wherein a main gear rotates respective small gears and each small gear transfers the motion to a respective secondary wheel assembly through the chain movement.

8. The cultivation system of claim 3 wherein the rotation of each secondary wheel assembly is controlled by a single different rotating mechanism which includes a second motor and a gear enabling separate rotation control upon each secondary wheel assembly.

9. (canceled)

10. The cultivation system of claim 1 wherein the secondary wheel assemblies are shaped as big cogwheels positioned in proximity to one another for enabling each secondary wheel assembly to rotate adjacent secondary wheels assemblies.

11. The cultivation system of claim 1 wherein the cultivation beds contain cultivation beds for growing mushrooms.

12. The cultivation system of claim 1 wherein the cultivation beds are utilized for growing agricultural products.

13. The cultivation system of claim 1 wherein adjacent secondary wheel assemblies rotate in opposite directions in synchronization.

14. (canceled)

15. The cultivation system of claim 7, wherein the motors are located on the triangular stand.

16. The cultivation system of claim 1 wherein the secondary wheel assemblies having at least two series each of at least three un-successive secondary wheels, wherein each series is connected by at least one frame to the central rotating mechanism, wherein a gearing mechanism rotated by at least one motor, rotates the series around said axis in opposite rotation directions.

17. The cultivation system of claim 1 wherein said external rotating wheel is rotated by motor.

18. The cultivation system of claim 1 wherein triangle holders hold unsuccessive secondary wheel assemblies, wherein each said assembly is connected to respective vertex of said triangle, wherein each said triangle connects to a different side of the central rotating mechanism through at least one gear to allow said triangle holders to rotate in opposite rotation direction.

19. The cultivation system of claim 1 wherein two sets of connected frames hold un-successive secondary wheel assemblies.

20. The cultivation system of claim 1 wherein said secondary wheel assemblies are tangential to the external wheel.

21. The cultivation system of claim 1 wherein said each frame that holds each assembly is a rod.

22. The cultivation system of claim 13 wherein each secondary wheel assembly has a central axis and at least two frames of spokes extending from the secondary axis wherein each spoke holds at least one cultivating bed.

23. The cultivation system of claim 1, wherein said central rotation mechanism is a hexagon frame connected to at least one rotating motor and at least one gear set, enabling rotating the secondary wheel assembly.

24. The cultivation system of claim 1 wherein said cultivation beds are detachable, wherein each said bed is fastened to said assembly by a fastening mechanism that allows removal and replacing of said beds.
